(19) United States
(12) Patent Application Publication
(10) Pub. No.: US 2019/0222028 A1
(43) Pub. Date: Jul. 18, 2019

(54) System and Method for Symmetric DC Regulation for Optimized Solar Power Generation and Storage

(71) Applicant: JLM Energy, Inc., Rocklin, CA (US)

(72) Inventors: Farid Dibachi, Lincoln, CA (US); Derek Denman, Rocklin, CA (US)

(73) Assignee: JLM Energy, Inc., Rocklin, CA (US)

(21) Appl. No.: 16/132,238

(22) PCT Filed: Mar. 15, 2017
(86) PCT No.: PCT/US17/22606

§ 371 Date: Sep. 14, 2018

Related U.S. Application Data
(60) Provisional application No. 62/308,367, filed on Mar. 15, 2016.

(51) Int. Cl. H02J 3/38; H02J 7/35; H02J 7/00; H02S 40/32; H02S 40/38

(52) U.S. Cl. CPC H02J 3/383; H02J 7/35; H02S 40/38; H02S 40/32; H02J 7/0068

(57) ABSTRACT

A system and method to increase solar system efficiency via a novel symmetric direct current regulation (SDCR) system to maximize useable solar power and optimize storage of energy in battery pack systems. The SDCR system maximizes delivery of generated solar power to the battery storage, utility grid or local building loads. The SDCR system comprises a plurality of photovoltaic arrays whose output voltage is mapped to the operational voltage of a LiFePO₄ battery storage system and a grid-tied inverter. Efficiency is increased by approximately 30% via (a) the elimination of in-line charge controllers for stepping down power from the PV array to the battery pack, and (b) the elimination of boost controllers for stepping up power to the requirements of the inverter. Thus, the SDCR system is able to support low-loss symmetric delivery of electrical power to both the battery storage pack and the inverter.

CROSS REFERENCE TO RELATED APPLICATIONS

This application claims the benefit of U.S. Provisional Application No. 62/308,367 filed Mar. 15, 2016.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### INCORPORATION-BY-REFERENCE OF MATERIAL SUBMITTED ON A COMPACT DISC

Not Applicable.

### FIELD OF THE INVENTION

The invention relates to systems for efficient management, regulation and use of direct current power produced from solar and wind power generation systems. More particularly, the invention relates to such a system to manage direct and alternating current associated with the use of residential, commercial and industrial solar energy.

### BACKGROUND

Widely deployed (high penetration) photo-voltaic (PV) solar arrays can make a positive contribution to the supply of energy but have an adverse effect on system capacity due to the timing of solar power availability as compared to the time profile of typical loads. The demand for electricity peaks after sunlight has diminished. It is therefore desirable to store PV energy for release later to offset peak demand. Secondly, a high penetration of PV arrays can cause severe power quality disturbances on the distribution system due to the cumulative effects of all the arrays being powered by a single source (sunlight) that is subject to atmospheric variation (clouds, fog, haze, etc.). Distribution system voltage and power control equipment cannot respond quickly enough to these variations to prevent widespread customer power quality issues such as flicker. Consequently, it is desirable to have a control system that can soften and minimize the power quality disturbances caused by these atmospheric variations.

Additionally, existing residential, commercial and industrial solar generation systems have limited ability to adapt to variable demands and operational requirements established by the utilities. Thus, additional flexibility in operational modes is necessary to generate adequate economic return to support the viability of future solar power generation systems. Further, the complexity and high cost associated with existing grid-tied solar systems, particularly in response to variable net-metering operational parameters, creates an additional impediment to further growth of the use of solar power generating systems. Consequently, it is desirable to have a solar and energy management system that can operate in a plurality of modes to both support utility demand when existent, to minimize the cost of grid-tied systems, and to allow profitable net-metering even in the face of downward-trending net metering payment structures.

Creating a power repository through the inclusion of a battery storage system with a solar power generation system adds complexity and integrates system bottlenecks and restrictions that can decrease the overall efficiency of the entire solar-storage system. Consequently, expected economic returns are actually lessened using battery storage. Additional elements in the solar generation and storage system will cause less of the solar power gathered by the photovoltaic arrays to be available for use due to additional losses

Referring to FIG.1 (Existing Art) and FIG. 2 (Existing Art), typical solar generation systems integrated with battery storage and tied to the grid (to support net metering) include components which degrade the overall efficiency of the solar power generation and delivery system, and, increase capital and lifecycle costs. As shown in FIG. 1 (Existing Art), in the existing art, a PV solar array generates electricity that is initially fed to a charge controller; the charge controller manages delivery of power to the battery storage system. Typically, the battery storage system is a 48-Volt lithium-ion battery pack. The battery charge controller is only 90% efficient; hence, 10% of the power produced by the PV solar array is lost when delivered to battery storage. A typical battery pack has a round-trip efficiency of 85%. Consequently, there is a 15% round-trip loss when power is drawn from the battery storage system. When AC power is needed, power is drawn from battery storage and delivered to a boost controller which raises the voltage to a level sufficient to be handled by a hybrid or standard inverter. Another 15% of the generated power is lost when routed through the boost controller to the inverter. Finally, the hybrid inverter delivers power to building loads or to the utility grid. Again, another 10% of the generated power is lost through the hybrid inverter. Consequently, the typical efficiency of a grid-tied solar system incorporating battery storage is only approximately 58%, whether the power is being delivered to support building loads or as a feed to the utility grid.

Minimizing battery charge cycles is important to the longevity of a battery storage system. The typical solar system with integrated battery storage will experience significant cycling of the battery storage system. This will quickly degrade the batteries and result in higher battery costs over the life of the system. Typically, battery storage systems are designed to address the typical building load requirements during low-sun periods, e.g., nighttime. Consequently, in the existing art, a battery will typically be cycled at least once per day, with an average of 400 cycles per year.

Hence, a need exists for a more efficient solar power generation and battery storage management system that provides higher efficiency and lower losses in delivering the originally generated solar power to support building loads or to deliver a portion to the utility grid. In addition, a significant need exists for such a system where battery life can be extended and charge cycles minimized. Further, a need exists for such a system where initial capital costs and system lifecycle costs can be reduced to allow greater accessibility.

### SUMMARY

The present invention is a system and method to support symmetric direct current regulation (SDCR) of power generated by photovoltaic solar arrays for flexible delivery to attendant battery storage systems, building loads or the utility grid. The SDCR system increases overall power delivery efficiency, provides enhanced flexibility in operation and reduces overall system cost. In one aspect, the invention comprises a photovoltaic solar array directly integrated to support parallel and simultaneous delivery of direct current power to both a battery storage system and a hybrid or standard, off-the-shelf, grid-tie inverter. The SDCR system is optimized to support battery energy storage, building loads, and to deliver power to the utility grid. The operational modes can be modified to suit an owner's requirements or preferences. The SDCR system incorporates control logic and electrical circuitry which allows the PV array to directly charge a battery storage pack without requiring a battery charge controller. In another aspect, the SDCR system causes PV array output voltage to be matched with the useful voltage of the battery storage pack.

The present invention supports the production and transmission of direct current of a renewable power source in parallel with a battery and grid-tied inverter with a throttling mechanism. When the renewable power source is able to generate power, direct current is produced and flows into the input of the inverter. As the inverter output power is throttled down to be less than the power generated by the renewable source, any additional power not used by the grid tied inverter will flow to the battery and be stored for later use. When the inverter is throttled above the power generated by renewable source, the battery will be discharged to provide the balance of power. In situations where the inverter does not have a throttling mechanism, a DC-DC converter can be placed in series with the inverter to control the current flow.

In a preferred embodiment, the battery storage pack comprises a plurality of LiFePO₄ or similar cells. For example, where the PV array presents a discharge voltage between 380 and 460 volts, the battery storage pack would include 128 LiFePO₄ battery cells.

In addition, the SDCR system may deliver power directly to an appropriate hybrid or standard, off-the-shelf, grid-tie inverter without the need for a boost controller to match the voltage requirement of the hybrid or grid-tied inverter. Consequently, the SDCR system provides symmetric and concurrent regulation of direct current from the PV array to support both battery storage and to deliver direct current directly to the inverter to support delivery of AC power to both the grid and building loads simultaneously.

Thus configured, the SDCR system, according to the invention, is capable of operating in several modes as required by various use scenarios and operational cases. Following is a brief description of six modes of operation supported by the SDCR system according to the invention.

In Mode 0, the SDCR system is idle and no power is delivered to either building loads, batteries or the grid.

In Mode 1, the SDCR system is in a PV net metering mode where extremely low power level requirements for building loads exist and battery storage is full.

In Mode 2, the SDCR system is operating in a battery supported demand shaving mode with no PV power generation. Generally, Mode 2 occurs when PV is not available, e.g., at night.

In Mode 3, the SDCR system is demand shaving, net metering and delivering PV power to charge the battery pack. PV delivery to the utility grid receives priority in Mode 3 to support demand shaving. Where additional demand exists for shaving, the excess demand is fulfilled by discharging batteries to the grid.

In Mode 4, the SDCR system charges batteries with power from the utility grid, based on no available PV power. This mode occurs typically at night, when low building loads exist and it is desirable to charge the batteries directly from the utility grid at lower power costs. In this mode, an internal charger converts AC power to DC to charge the storage batteries.

In Mode 5, the SDCR system charges the battery pack with power from the utility grid while the PV is delivering power to the utility grid in a net metering state. In this mode, the PV power is too low to optimally charge the batteries. Hence, the system allows the PV to net meter while the batteries are charged from the utility grid.

The SDCR system is adaptable to suit these and other desired operational scenarios. Consequently, the SDCR system can adapt to priority objectives, including, for example, to maximize power availability, minimize power cost, maximize revenue, support demand shaving, and ensure adequate power storage in anticipation of grid unavailability or PV unavailability.

### BRIEF DESCRIPTION OF THE SEVERAL VIEWS OF THE DRAWINGS

These and other features, aspects and advantages of various embodiments of the present invention will become better understood with regard to the following description, appended claims, and accompanying drawings where:

FIG. 1 is a component diagram of a typical solar and battery storage system according to the existing art;

FIG. 2 is a block diagram of the typical arrangement of existing art solar and battery storage system illustrated in FIG. 1;

FIG. 3 is a component diagram of the solar and battery storage system according to the present invention;

FIG. 4 is a block diagram of the solar and battery storage system illustrated in FIG. 3, wherein the PV array is coupled with the grid-tied inverter, according to the present invention;

FIG. 5 is a block diagram of the solar and battery storage system illustrated in FIG. 3, wherein the PV array is coupled with the DC-DC converter, according to the present invention;

FIG. 6 is a chart illustrating the voltage versus depth of discharge for a LiFePO₄ single cell battery;

FIG. 7A is a chart illustrating battery pack voltage (128 LiFePO₄ batteries) versus depth of discharge;

FIG. 7B is a chart illustrating battery pack voltage (8 LiFePO₄ batteries) versus depth of discharge;

FIG. 8 is a chart illustrating power production of a photovoltaic array as a function of maximum power point tracking (MPPT) within the useful voltage range of the battery pack;

FIG. 9 is an enlargement of a portion of the chart shown in FIG. 8, emphasizing the voltage of the photovoltaic array for different levels of irradiation across an operable range of the battery pack;

FIG. 10 is a block diagram of the structure of a first embodiment of the system, according to the invention;

FIG. 11 is a block diagram of the structure of an alternative embodiment of the system, according to the invention; and

FIG. 12 is a block diagram of the structure of a further embodiment of the system, according to the invention.

FIG. 13 is a block diagram of the structure of a further embodiment of the system, comprising a PV array coupled with a grid-tied string inverter having power output throttling, according to the invention.

FIG. 14 is the configuration illustrated in FIG. 13 but further including an AC isolation and rectification module and buck/boost stage, according to the invention.

FIG. 15 is a block diagram of the structure of a further embodiment of the system, comprising a PV panel coupled with a DC-DC converter, according to the invention.

FIG. 16 is the configuration illustrated in FIG. 15 but further including an AC isolation and rectification module and buck/boost stage, according to the invention.

The accompanying drawings numbered herein are given by way of illustration only and are not intended to be limitative to any extent. Commonly used reference numbers identify the same or equivalent parts of the claimed invention throughout the several Figures.

### DETAILED DESCRIPTION

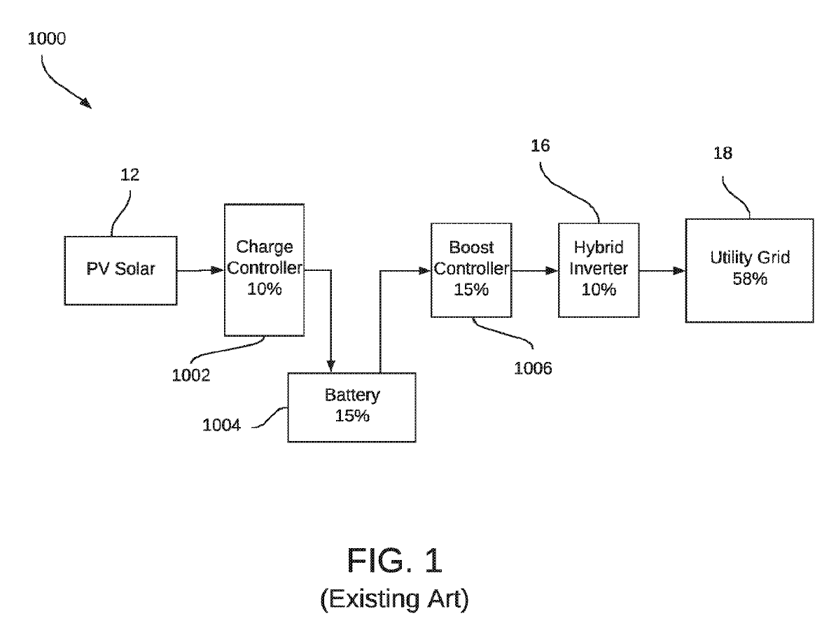

FIG. 1 through FIG. 16, wherein like parts are designated by like reference numerals throughout, illustrate example embodiments of a system for managing a comprehensive solar power generation, storage, and delivery infrastructure, according to the present invention. Although the present invention will be described with reference to the example embodiments illustrated in the figures, it should be understood that many alternative forms can embody the present invention. One of skill in the art will additionally appreciate different ways to alter the parameters of the embodiments disclosed, such as the size, shape, or type of elements or materials, in a manner still in keeping with the spirit and scope of the present invention.

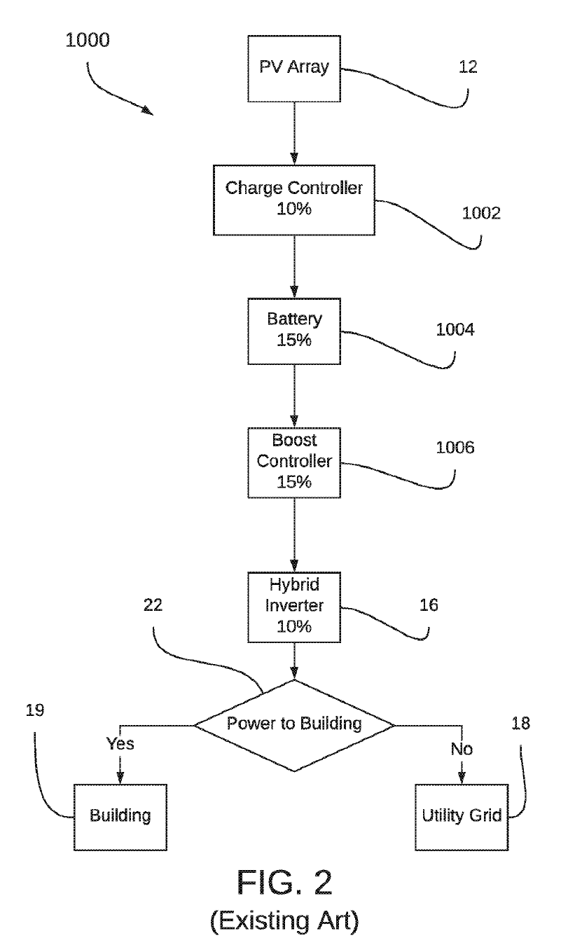

FIG. 1 (Existing Art) and FIG. 2 (Existing Art) are illustrations of the components typically incorporated in existing solar power generation, battery storage and building/grid delivery systems. A typical existing energy storage system module 402 requires multiple stages of DC voltage conversion, resulting in high efficiency losses. For example, existing systems require inclusion of a battery charge controller 1002 (for delivery of higher voltage power (e.g., 400 V, 1000 V, 1500 V et al) from the PV solar array 12 to lower voltage battery storage systems 14 (e.g., 48-volt battery packs 210).

Referring to FIG.1 (Existing Art) and FIG. 2 (Existing Art), typical solar generation systems that are integrated with battery storage systems 14 and tied to the utility grid 18 to support net metering include several components which degrade the overall efficiency of the solar power generation and delivery system.

In every case, a plurality of photovoltaic strings 12 converts solar energy into direct-current (DC) electricity. In the existing art, the photovoltaic strings 12 generate electricity at a higher voltage (e.g., 400V) than the voltage supported by the battery storage system 14 (e.g., 48V). A battery charge controller 1002 regulates electricity flow into the battery packs 210 in part by reducing the voltage. The battery charge controller 1002 consumes about 10% of the applied electricity in the process. Electricity sent through the battery charge controller 1002 is used to charge a 48V battery pack 210. Storage and re-transmission via the battery pack 210 results in a further 15% multiplicative power loss. To use the power stored in the battery pack 210 via AC appliances, the electricity must first be converted back to AC and the voltage increased. The voltage is increased via a boost controller 1006 and the DC power is converted to AC via a hybrid or standard, off-the-shelf, grid-tied inverter 16, causing further losses of 15% and 10%, respectively. Once the power has been converted back to AC, the electricity may alternatively be either utilized to power the building 19 or sold to the utility grid 18. The total efficiency of the system is calculated by multiplying the efficiency at each stage, which in this existing art configuration results in an efficiency rating of 58%.

In greater detail, as shown in FIG. 1 (Existing Art), the PV solar array 12 generates electricity which is initially fed to a charge controller 1002; the charge controller 1002 manages delivery to the battery storage system 14, typically comprising a 48-Volt lithium ion battery. The charge controller 1002 is only 90% efficient; hence, 10% of the power produced by the PV solar array 12 is lost when delivered to battery storage. A typical battery pack 210 has a delivery efficiency of 85%, also known as round-trip efficiency. Consequently, there is a 15% round-trip loss of power delivered from the battery storage system 14. Next, power is delivered from the battery storage system 14 to a boost controller 1006 which raises the voltage to a level sufficient to be handled by a hybrid or standard inverter 16, which will convert DC power to AC and deliver that power to either support building 19 loads or the utility grid 18. Another 15% of the originally generated power is lost when routed through the boost controller 1006 to the hybrid inverter 16. Finally, as the inverter 16 delivers power to building 19 loads or to the utility grid 18, another 10% of the generated power is lost. Consequently, existing grid-tied solar systems incorporating battery storage are only approximately 58% efficient, whether the power is being delivered to support building 19 loads or to the utility grid 18.

Existing systems also suffer from excessive cycling of their battery packs 210 which shortens the life of the system and increases life cycle cost. Where power is first delivered directly to the battery storage system 14 via a charge controller 1002 and then subsequently flows from the battery storage system 14 to the boost controller 1006 for delivery to the inverter 16, the battery storage system 14 will experience significant cycling at approximately 400 cycles per year. It is well known that batteries will quickly degrade as charge/discharge cycles increase. Consequently, increased battery cycling will predictably result in higher life cycle costs for the system.

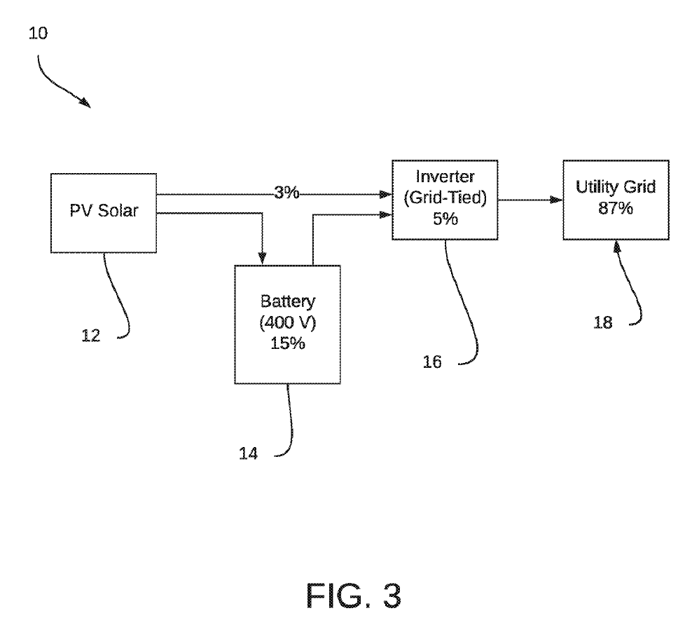

Now referring to FIG. 3, an illustration of the primary components associated with the system and method for symmetric direct current regulation (SDCR) for optimized solar power generation, storage and delivery is shown. In contrast to the Existing Art as illustrated in FIG. 1, the SDCR system 10 according to the present invention does not require the use of either a charge controller 1002 or boost controller 1006. Instead, the SDCR system 10 uniquely matches output PV voltage with voltage requirements of both the inverter 16 and battery storage system 14. Consequently, the system and method of the invention can be adapted and scaled to support varying PV voltage levels and varying battery voltage levels. The SDCR system 10, in a first embodiment, comprises a PV solar array 12 which is directly connected to both an inverter 16 and an attendant battery storage system 14. The PV solar array 12 can scale from lower kilowatt residential systems, commercial systems, industrial scale systems and to utility-scale installations.

In this first embodiment, the direct current (DC) produced by the PV solar array 12 is directly and symmetrically fed to both a 400V battery storage system 14 and a 400V inverter 16. The inverter 16 may be either a hybrid inverter or a standard grid-tied inverter. In a first operational mode, where power is fed to the battery and then the grid-tied inverter, the SDCR system 10 will experience an aggregate loss of 23% before delivery to either the utility grid 18 or building 19 loads, providing an overall operating efficiency of approximately 77%. Note that this efficiency is still approximately 20% greater than that of the existing art. Where power is fed directly to the inverter 16, bypassing the battery storage system 14, the SDCR system 10 will experience a loss of only 5% before delivery to building 19 loads or the utility grid 18, providing an overall efficiency of approximately 95%.

If the SDCR system 10 is operating with a 50-50 split between delivery to the battery storage system 14 and direct delivery to the grid-tied inverter 16, the SDCR system 10 experiences average losses of 13% with an overall efficiency of approximately 88%. Thus, in comparison to the efficiency of the existing solar battery storage configurations at 58%, the SDCR system 10 according to the invention will provide increased efficiency of approximately 30%.

Additionally, given that the SDCR system 10 is able to bypass battery storage for approximately 50% of the required power delivery, the required cycles per for the batteries will likewise be decreased 50% from 400 cycles per year to 200 cycles per year. The cost associated with a comprehensive solar power generation and battery storage system 14 is driven significantly by the cost of the battery pack 210. Consequently, the associated capital and life cycle cost based on the SDCR system 10 will be significantly less than that of existing system configurations.

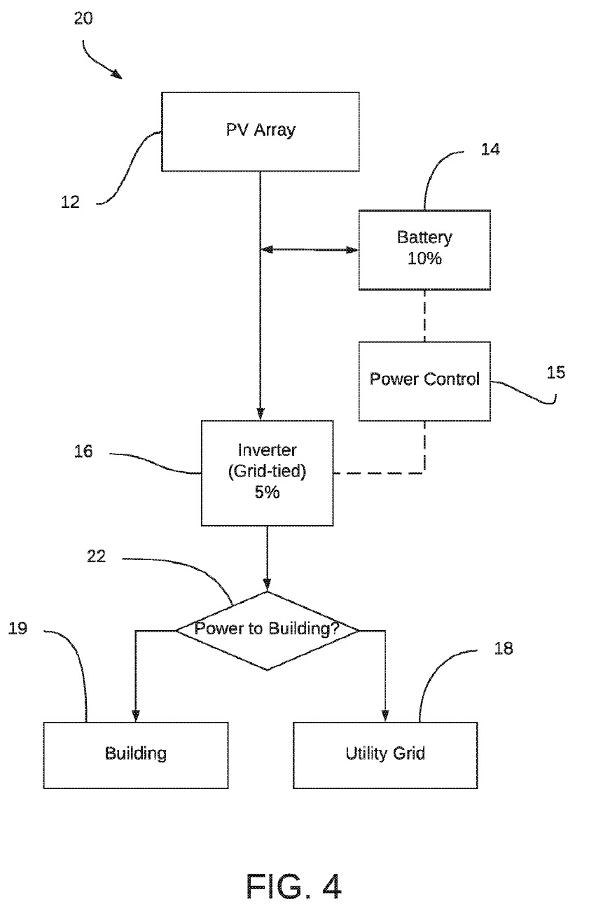

Referring now to FIG. 4, a block diagram illustrating the operation of the SDCR system according to the invention with the PV system and battery system directly coupled to the input of the grid-tied inverter is shown. The SDCR system 10 determines whether DC from the PV solar array 12 is first delivered to interim storage in a matched battery pack 210 or delivered directly to the hybrid or standard grid-tied inverter 16. Since the present invention relies on a battery storage system 14 with a higher voltage rating, e.g., 400V as compared to 48V, charge controllers 1002 and boost controllers 1006 to step the voltage down and back up are unnecessary. Although shown as designed for a 400V PV system, the SDCR system 10 may be adapted to support PV systems having higher voltage ratings, including 1000V and 1500V. The SDCR system 10 may be adapted for higher voltage PV systems that might be developed in the future. Furthermore, the SDCR system 10 allows the battery charge/discharge process to be skipped entirely. Electricity generated by the PV solar array 12 may be allocated either to the battery or directed toward immediate use. If the electricity is allocated for immediate use either by the building 19 or the utility grid 18, the DC electricity is sent directly to a grid-tied inverter 16, without the need for any prior voltage stepping.

The system current control logic monitors the current flow in and out of the battery storage system 14 and throttles the grid tied inverter 16 to control the rate of battery charging and discharging. The SDCR current control logic manages the current delivery as follows. If the battery storage system 14 is full and discharging, the inverter 16 is set to output the required power. If the battery storage system 14 is charging, the battery relay 208 is opened and the inverter 16 is set to output all available renewable power. If the battery storage system 14 is operational and discharging, the inverter 16 is set to output required power. If the battery storage system 14 is charging, and the battery is in a bulk charging state, the inverter 16 is set to minimum output power.

If the battery storage system 14 is in an absorb charging state, the SDCR system 10 calculates the instantaneous power required to charge battery packs 210 at a constant voltage. Hence, the power of the inverter 16 is set according to the following relationship:

Pᵢₙᵥₑᵣₜₑᵣ=P_{renewable}−P_{battery}_{_}_{absorb}_{_}_{charge}

If the battery is in float charging state, then the system calculates the instantaneous power required to charge batteries at constant current of 0.05 C, according to the following relationship:

Pᵢₙᵥₑᵣₜₑᵣ=P_{renewable}−P_{battery}_{_}_{float}_{_}_{charge}

If the battery is empty and discharging, then the system causes the battery relay 208 to open and sets the inverter 16 to output all available renewable power. If the battery 1004 is empty and charging, then they system sets the inverter 16 to minimum output power.

In a preferred embodiment, based on the exist significant presence of 400V PV solar arrays 12, 400V PV strings 12 are conductively connected to a 400V battery storage system 14 in a manner that allows the PV solar array 12 to charge the battery pack 210 directly. In this preferred embodiment, the battery storage system 14 consists of 128 LiFePO4 (lithium iron phosphate) battery cells arranged in series. Other similar battery storage systems 14 may be used in lieu of LiFePO4 battery cells. The hybrid or standard grid-tied inverter 16 is configured to service the symmetric output of both the photovoltaic strings 12 and the battery storage system 14, wherein both feeds are delivered to the inverter 16 at approximately 400V. Thus, the SDCR system 10 eliminates the need for both i) a charge controller 1002 for delivery of power to the battery storage system 14 and ii) a boost controller 1006 for delivery from the battery storage system 14 to the inverter 16.

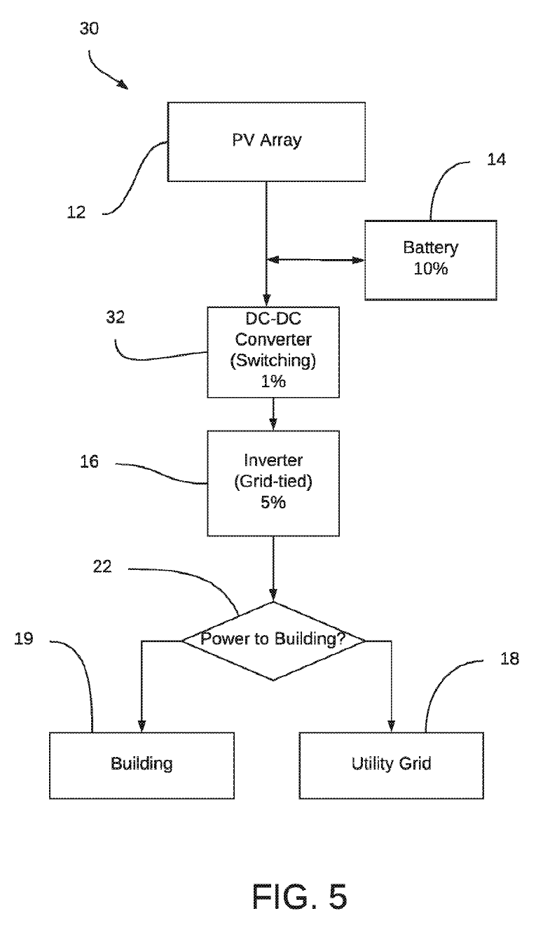

Referring now to FIG. 5, a block diagram illustrating the operation of an alternative embodiment of the SDCR system 10 according to the invention with the PV solar array 12 and battery storage system 14 directly coupled to the input of the internal DC-DC converter 32 is shown. The system current control logic monitors the current flow in and out of the battery storage system 14 and throttles the DC-DC converter 32 to control the rate of battery charging and discharging.

Now, in greater detail, the structure and operation of the SDCR system 10 according to the invention is described. The SDCR system 10, in a preferred embodiment, is predicated on the use of LiFePO4 battery cells. However, the SDCR system 10 may be implemented using alternative battery storage systems 14 having different depth of discharge versus voltage rating curves.

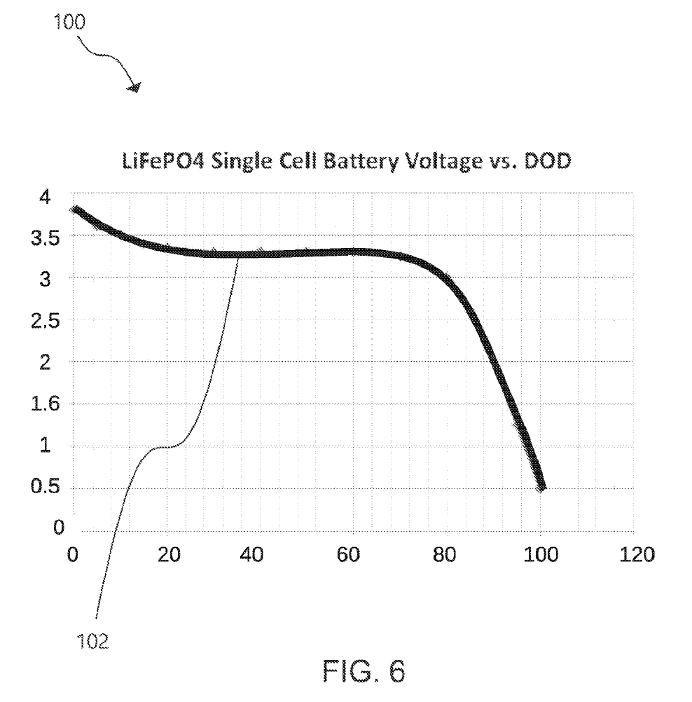

Referring to FIG. 6, a chart illustrating the relationship between the voltage of a single cell LiFePO4 battery and the depth of discharge (DOD) is shown. The discharge curve of a single LiFePO4 cell shows the stable cell voltage throughout the useable voltage range 126 of the battery's depth of discharge. The voltage for a single cell LiFePO4 battery reaches an effective plateau between 3 and 3.5 volts between 20% and 80% DOD. The SDCR system 10 leverages this voltage plateau to create an effective control method which supports direct connection of the PV solar arrays 12 to the battery storage system 14.

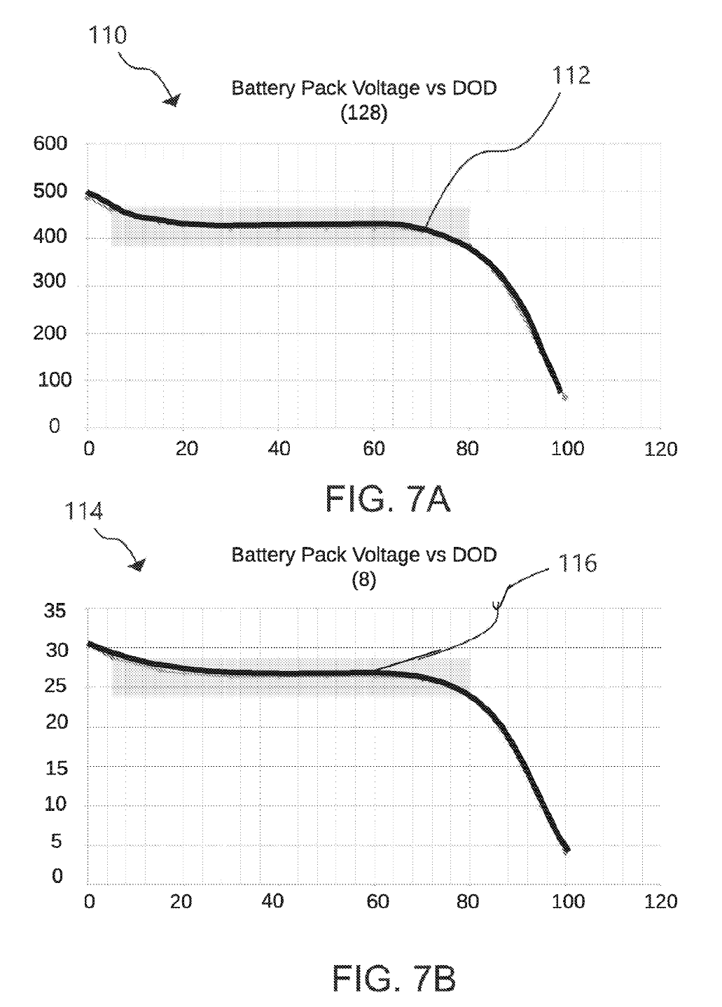

Now, referring to FIG. 7A, a chart of voltage versus DOD for a larger battery pack 210 comprised of a plurality of LiFePO4 cells is shown. In this instance, the battery pack 210, comprised of 128 LiFePO4 battery cells according to the invention, exhibits a stable voltage plateau between 460 volts (@5% DOD) and 384 volts (@80% DOD). Thus, the battery storage system 14 exhibits significant power density across a significant DOD with a stable operational voltage level.

Now, referring to FIG. 7B, a chart of battery pack voltage versus DOD for a battery pack comprised of eight battery cells in series is shown. In this instance, the battery pack 210, comprised of 8 LiFePO4 battery cells according, exhibits a stable voltage plateau between 30.4 volts (@5% DOD) and 24 volts (@80% DOD). Thus, the battery storage system 14 exhibits significant power density across a significant DOD with a stable operational voltage level.

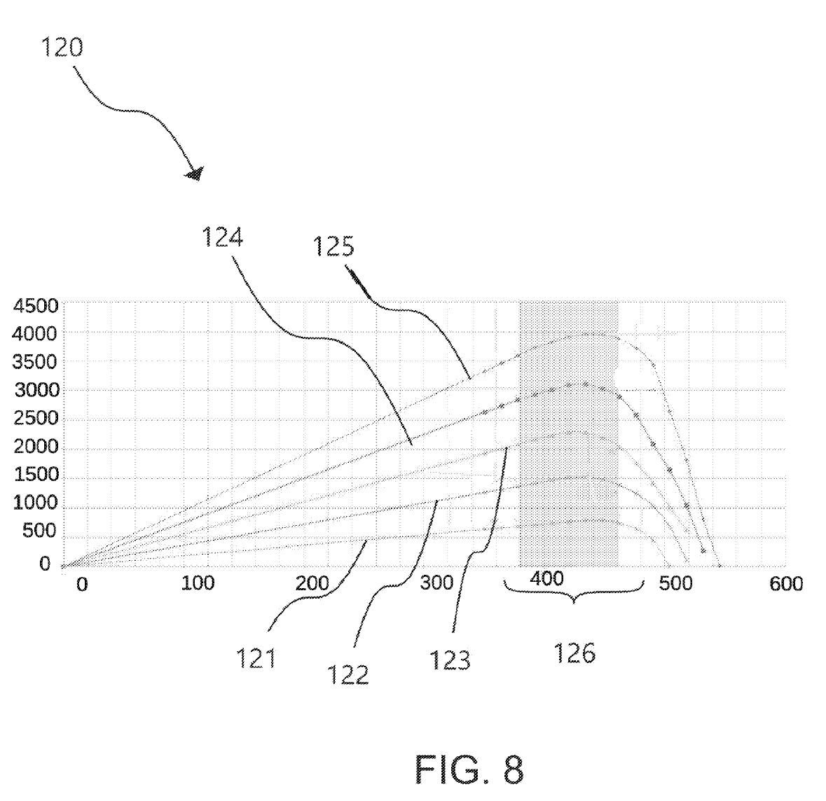

Referring now to FIG. 8, a chart illustrating the power production of a typical photovoltaic string 12 as a percentage of maximum power point tracking (MPPT) for various levels of solar irradiation in Watts per square meter (W/m2), from 200 W/m2 to 1000 W/m2, is shown. At 200 W/m2, the sky is typically cloudy with a minimum amount of sunshine, or, the sun is setting; at 1000 W/m2, the sky is clear and sunny. The SDCR system 10 is configured for optimal operation between 380 volts and 460 volts based on the performance characteristics of the LiFePO4 battery storage system 14 design according to the invention. Still referring to FIG. 8, the 400V photovoltaic string 12 delivers between 380 and 460 volts across all levels of irradiation (between 200 W/m2 and 1000 W/m2) in an optimum MPPT range for each irradiation level. Thus, the SDCR system 10 is configured to ensure that the PV voltage level is sufficient to drive current into the battery pack 210.

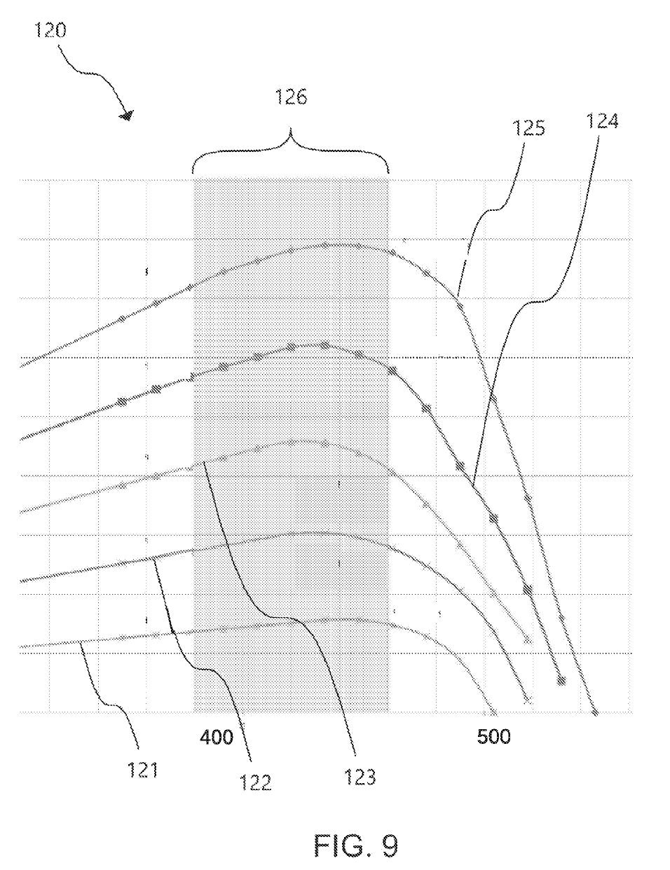

Referring now to FIG. 9, an enlarged view of a portion of the chart in FIG. 8 is provided, emphasizing the useable voltage range of the LiFePO4 battery storage pack between 380 volts and 460 volts, i.e., the useful capacity of the batteries, contrasted against the voltage output of the photovoltaic string 12 across multiple irradiation levels. The SDCR system 10 manages the output of the photovoltaic string 12 to correspond with the usable operational range of the LiFePO4 battery storage system 14 while still ensuring that the PV solar array 12 is able to operate within a suitable MPPT range at each solar irradiation level. If slight tuning is required to optimize energy production, the output voltage of the PV solar array 12 or the input voltage of the battery pack 210 may be modified.

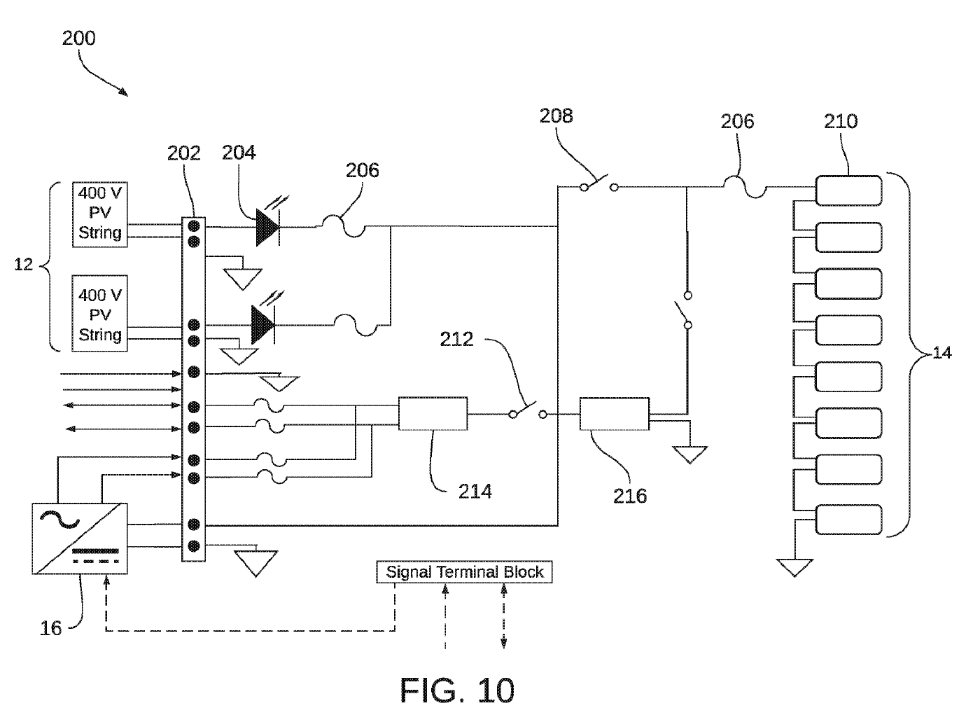

Referring now to FIG. 10, a block diagram of an embodiment of the system is shown. The SDCR system 10, in one configuration, is comprised of a plurality of photovoltaic strings 12 configured to optionally provide electricity to a plurality of power sinks, including battery packs 210, the attached building 19, or to the utility grid 18. The photovoltaic strings 12 are conductively attached to a power terminal block 202 and isolated from the rest of the SDCR system 10 with protection diodes 204 and current regulators 206. When a battery relay 208 is in the closed position, electricity is transferred to and stored in a plurality of battery packs 210 aligned in series. In this embodiment, the individual LiFePO4 battery packs 210 are 52 V systems supporting 50 Amp-hours per battery pack 210. Other similar battery packs 210 may be used to establish the appropriate voltage level for the battery storage system 14. The battery storage system 14 is protected by a current regulator 206. Additionally, power from the photovoltaic strings 12 may be delivered directly to a grid-tied inverter 16 that converts a DC current to a grid-compatible AC current. The AC current is then supplied alternatively to either the utility grid 18 or to the building 19 loads.

Referring still to FIG. 10, the battery packs 210 may supply power to the utility grid 18 or to the building 19. When the battery relay 208 is in the closed position and the battery packs 210 are charged, excess electricity will flow from the battery storage system 14 to the grid-tied inverter 16. The various protection diodes 204 ensure that electricity does not flow back into the photovoltaic strings 12. The battery packs 210 may also be charged directly from the utility grid 18. When the battery relay 208 is in the open position and the charger relay 212 is in the closed position, AC power from the utility grid 18 is sent through an AC isolation and rectification module 214, through a boost stage 216, and to the battery packs 210.

The charger relay 212, battery relay 208, and other components may be controlled electronically via associated software control systems. The management software enables the SDCR system 10 to function in a plurality of modes. The PV solar arrays 12 may provide power to the utility grid 18, battery packs 210, or the loads associated with the building 19, while the battery packs 210 may be charged by the photovoltaic strings 12 or the utility grid 18. The building 19 loads may be addressed by power from the PV solar arrays 12, stored power in the battery packs 210, or directly from the utility grid 18. Finally, under certain circumstances it may be preferred for the photovoltaic strings 12 to supply power to the utility grid 18 while the battery packs 210 are charged from the utility grid 18.

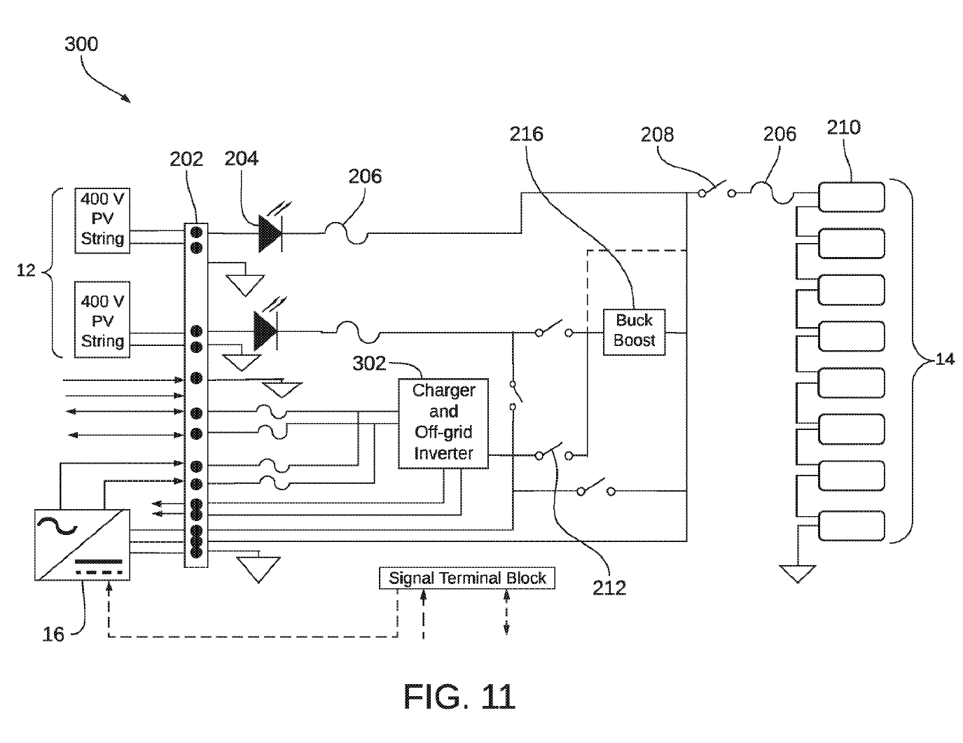

Referring now to FIG. 11, a block diagram of a second embodiment of the system is shown. The second embodiment also contains a plurality of photovoltaic strings 12, battery packs 210, a grid-tied inverter 16, and connectivity to the building 19 and utility grid 18. However, this embodiment allows for multiple photovoltaic strings 12 of varying voltages. For example, one photovoltaic string 12 may be rated for a 400V output, while another photovoltaic string 12 is rated for a 100V output. The lower-rated photovoltaic strings 12 are attached to the SDCR system 10 via a boost stage 216 that converts power output from all photovoltaic strings 12 to a uniform voltage. Additionally, this embodiment also employs an optional charger and off-grid inverter 302.

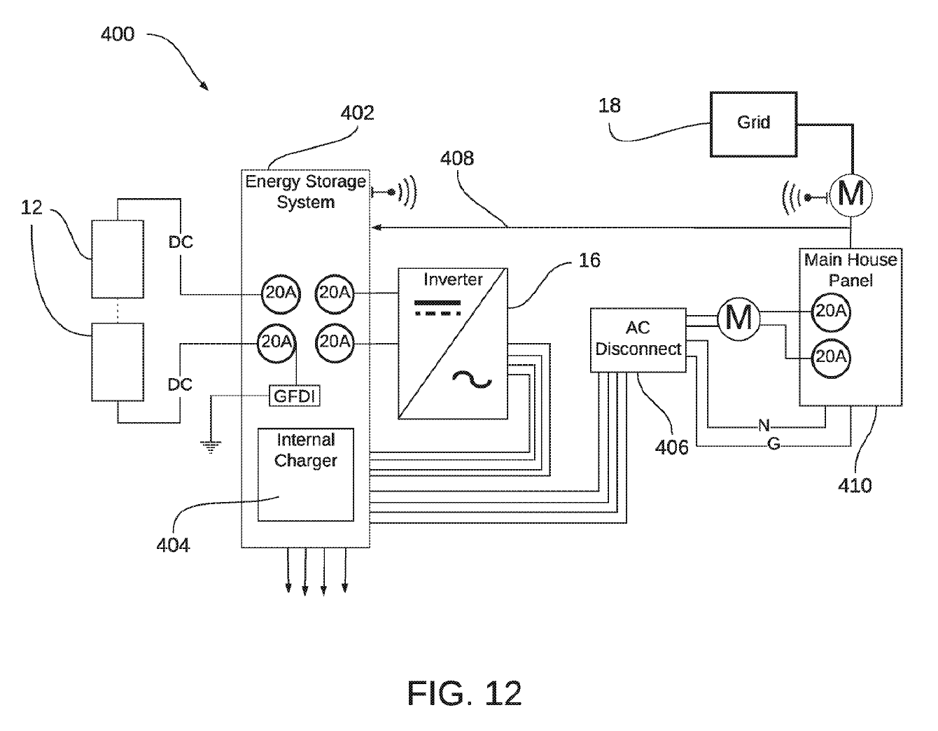

Referring now to FIG. 12, an exemplary installation diagram of the energy storage system leveraging SDCR is shown. A plurality of photovoltaic strings 12 may be attached to an energy storage system module 402 housing the primary battery packs 210. The energy storage system module 402 also includes connections to an internal charger 404, an AC disconnect panel 406, a power inverter 16, and external loads. Optionally, the energy storage system module 402 receives real-time grid data via a power measurement sensor 408 which communicates to a central controller via hardwire or a wireless protocol such as Wi-Fi, ZigBee, or Bluetooth.

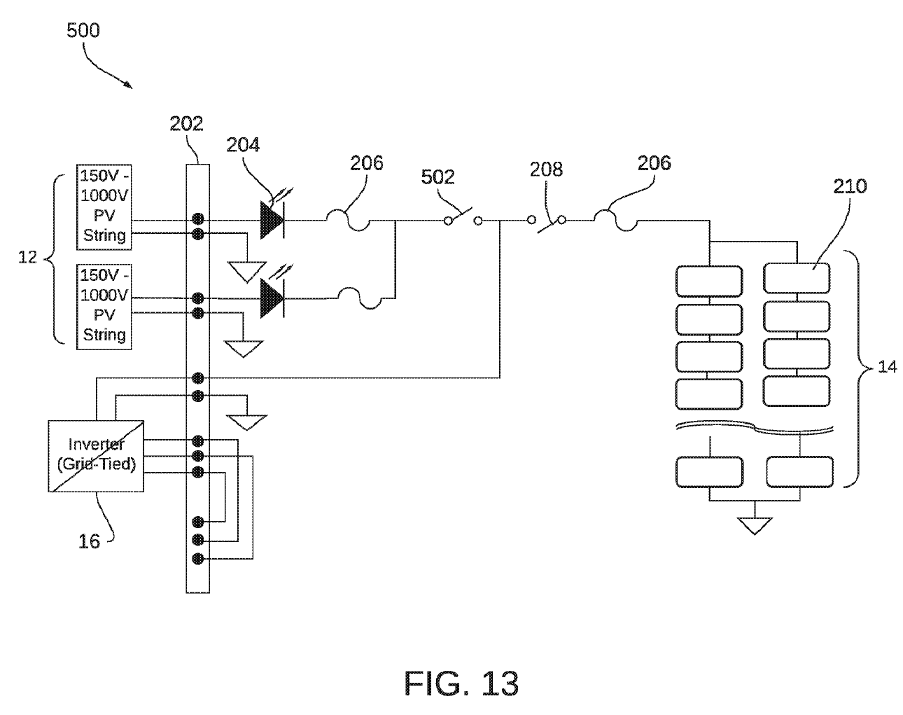

Referring now to FIG. 13 through FIG. 16, additional block diagrams of various embodiments of the SDCR system 10 is shown. FIG. 13 is an illustration of the SDCR system 10 wherein the SDCR system 10 is used with a PV solar array 12 and string inverter 16. The current flow is controlled by throttling the power export of the grid-tied string inverter 16. As the inverter 16 power export is throttled down to 0% of the nameplate power, battery charging will increase to 100% of available PV power. As the inverter 16 power is throttled up to 100% of the nameplate power, battery charging will decrease. If the available PV power is less than the inverter's nameplate power, the battery packs 210 will be discharged to supply and additional current needed. Battery cells may be put in series such that the battery stack voltage matches the Vmp of the PV solar array 12. Battery stacks may be put in parallel to increase capacity of energy storage system.

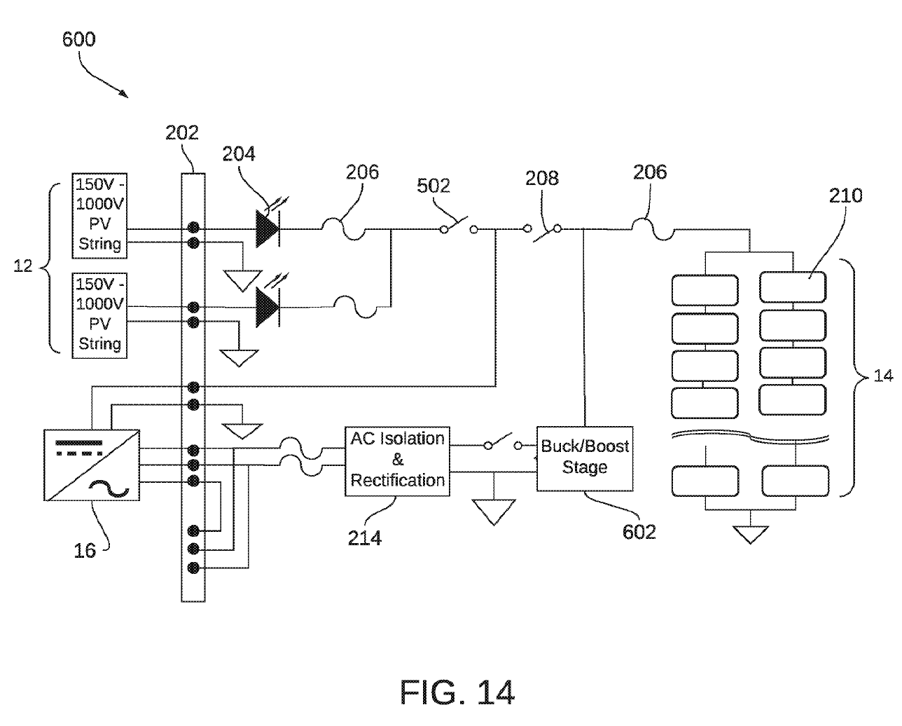

FIG. 14 is the equivalent to the arrangement shown in FIG. 13, but further including an AC isolation and rectification module 214 with a buck/boost stage 602.

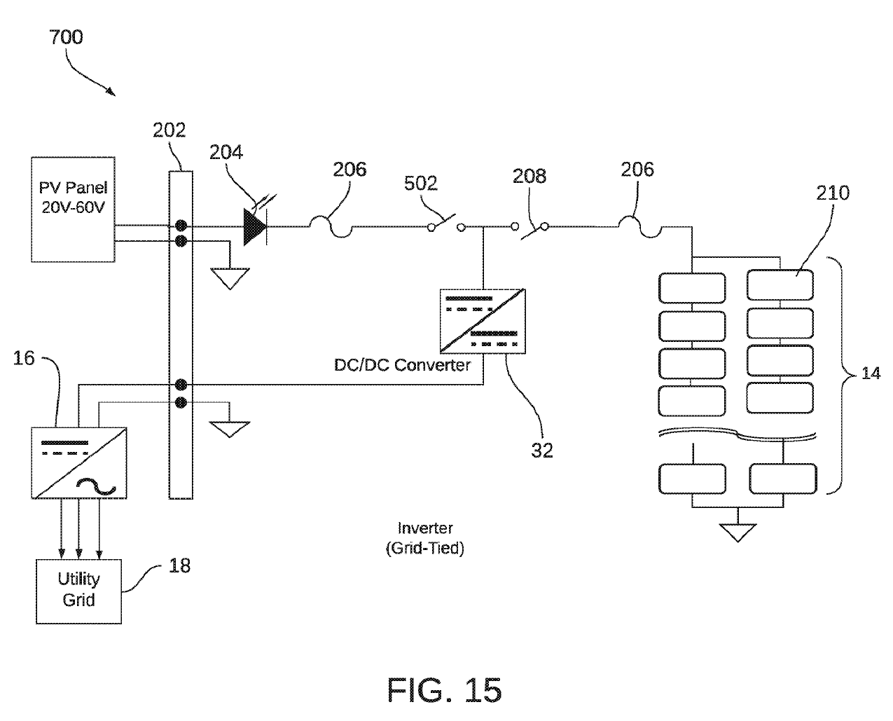

FIG. 15 is a block diagram illustration of the SDCR configuration wherein the SDCR system 10 is used with a single PV panel having a DC-DC converter 32 and micro-inverter. Current flow is controlled by throttling the internal DC-DC converter 32, limiting the power available to the micro-inverter. As the DC-DC converter 32 is throttled down to 0% of the nameplate power, battery charging will increase to 100% of available PV power. As the DC-DC converter 32 is throttled up to 100% of the nameplate power, battery charging will decrease. If the available PV power is less than the inverter's nameplate power, the battery packs 210 will be discharged to supply any additional current needed. Battery cells may be put in a series arrangement such that the battery stack voltage matches the Vmp of the PV solar array 12. Battery stacks may be placed in a parallel arrangement to increase capacity of the energy storage system.

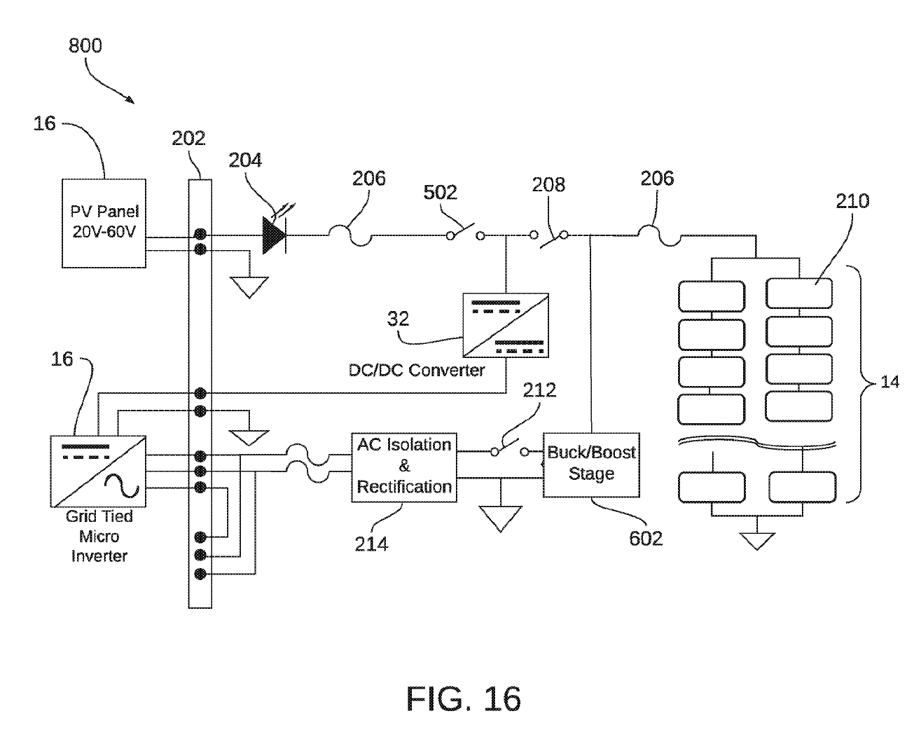

FIG. 16 is equivalent to the arrangement shown in FIG. 15, but further including an AC isolation and rectification module 214 with a buck/boost converter stage 602.

In some instances, electricity from the photovoltaic strings 12 may travel either through the battery storage system 14 to the power inverter 16 or directly to the power inverter 16. If desired, AC current from the power inverter 16 may be fed back to the energy storage system module 402 for delivery to an internal charger 404 which can feed the battery packs 210. AC power is also fed back to the energy storage system module 402 to power controls associated with the external loads and those associated with complete off-grid operation. The energy storage system module 402 also provides various communication links, including an RS-485 communication link for controlling the inverter 16 operation. The energy storage system module 402 controls power delivery and can reroute the AC power to external loads, such as home appliances, or to the utility grid 18.

Power that is routed to the utility grid 18 passes to the main house panel 410 through the AC disconnect panel 406 before traveling to the utility grid 18. The connection between the main house panel 410 and the utility grid 18 may have a power measurement sensor 408 which communicates directly with the energy storage system module 402. Thus, the energy storage system module 402 may measure and regulate power traveling to and from the utility grid 18. In another aspect, the SDCR system 10 may include an additional power monitoring sensor between the AC disconnect panel 406 and the main house panel 410 to indicate when other control strategies need to be deployed, such as emergency interruption of power flow to the main house panel 410 and disconnect of the main house panel 410 from the SDCR system 10 to avoid reverse power flow, which could potentially damage components.

In one version, a power monitor transmits data to the energy storage system module 402 via a wireless protocol such as ZigBee. Other wireless protocols such as, for example, Wi-Fi or Bluetooth, may be used to transmit data between control points in the energy storage system, depending on the distance between various components. Hardwired data communication links may also be deployed in the SDCR system 10 to support data transport and control signal delivery.

In use and operation, the SDCR system 10 provides symmetric and concurrent regulation of direct current from the PV solar array 12 to support both battery energy storage and to deliver direct current directly to the inverter 16 to support delivery to the utility grid 18 and building 19 loads simultaneously, with minimized power loss.

Thus configured, the SDCR system 10, according to the invention, is capable of operating in several modes as required by various use scenarios and operational cases. Following is a brief description of six modes of operation associated with the SDCR system 10 according to the invention.

In Mode 0, the SDCR system 10 is idle and no power is delivered to either building 19 loads, battery packs 210 or the utility grid 18. In Mode 1, the SDCR system 10 is in a PV net metering mode where extremely low power level requirements for building 19 loads exist and battery storage is full. In Mode 2, the SDCR system 10 is operating in a battery-supported demand shaving mode with no PV power generation. Generally, Mode 2 occurs when PV is not available, e.g., at night. In Mode 3, the SDCR system 10 is demand shaving, net metering and delivering PV power to the battery storage system 14. PV delivery to the utility grid 18 receives priority in Mode 3 to support demand shaving. Where additional demand exists for shaving, the excess demand is fulfilled by discharging batteries to the utility grid 18. In Mode 4, the battery packs 210 are charging from the utility grid 18, based on no available PV. This mode occurs typically at night, when building 19 power demands are low. Thus, it is preferable to charge battery packs 210 directly from the utility grid 18 at lower costs of power. The stored power may then be sold via net metering when power costs are higher. In Mode 5, the battery packs 210 are charging from the utility grid while the PV is in a net metering state. In this mode, the PV power is too low to optimally charge the batteries. Hence, the system allows the PV to net meter while the batteries are simultaneously charged from the utility grid 18.

The SDCR system 10 is adaptable to suit multiple desired optimal operational scenarios for each use case, for example, to maximize power availability, minimize power cost, maximize revenue, support demand shaving, and ensure adequate power storage in anticipation of utility grid 18 unavailability or PV unavailability.

The present invention has been particularly shown and described with respect to certain preferred embodiments and features thereof. However, it should be readily apparent to those of ordinary skill in the art that various changes and modifications in form and detail may be made without departing from the spirit and scope of the inventions as set forth in the appended claims. The inventions illustratively disclosed herein may be practiced without any element which is not specifically disclosed herein.

We hereby claim:

1. An SDCR system supporting symmetric direct current regulation of power comprising:
a. One or more photovoltaic (PV) panels;
b. a battery storage system;
c. an inverter;
d. said one or more PV panels directly connected to said inverter and said battery storage system;
e. SDCR control logic and electrical circuity for charging a battery storage pack directly without an intervening battery charge controller;
f. said SDCR control logic and circuity causing said one or more PV panels output voltage to match the useful voltage range of a battery storage pack in said battery storage system; and,
g. said SDCR control logic and circuitry providing parallel and simultaneous delivery of direct current power to said battery storage system and said inverter, thereby allowing delivery of power to support battery energy storage, building loads and to deliver power to the utility grid.

2. The SDCR system of claim 1 further comprising:
a. Said one or more PV panels configured to form an array of PV panels.

3. The SDCR system of claim 1 further comprising:
a. said battery storage pack including a plurality of battery cells; and,
b. said plurality of battery cells arranged in series to match a discharge voltage of said one or more PV panels.

4. The SDCR system of claim 3 wherein said plurality of battery cells are LiFePO₄.

5. The SDCR system of claim 1 wherein said SDCR control logic and circuitry is capable of operating the SDCR system in multiple modes including:
a. Mode 0, wherein the SDCR system is idle and no power is delivered to building loads, battery energy storage or the grid;
b. Mode 1, wherein the SDCR system is in a PV net metering mode where extremely low power level requirements for building loads exist and battery storage is full;
c. Mode 2, wherein the SDCR system is operating in a battery supported demand shaving mode with no PV power generation;
Mode 3, wherein the SDCR system is demand shaving, net metering and delivering PV power to charge the battery pack;
d. Mode 4, wherein the SDCR system charges batteries with power from the utility grid, based on no available PV power; and,
e. Mode 5, wherein the SDCR system charges the battery pack with power from the utility grid while the PV is delivering power to the utility grid in a net metering state

6. An SDCR system supporting symmetric direct current regulation of power comprising:
a. a photovoltaic (PV) solar array;
b. a battery storage system;
c. a DC-DC converter;
d. said PV solar array and said battery storage system directly coupled to an input of said DC-DC converter;
e. said SDCR control logic and circuity causing photovoltaic array output voltage to match the useful voltage range of a battery storage pack in said battery storage system;
f. said SDCR control logic and circuitry providing parallel and simultaneous delivery of direct current power to said battery storage system and said DC-DC converter, thereby allowing delivery of power to support battery energy storage, building loads and to deliver power to the utility grid.

7. The SDCR system of claim 5 wherein said PV solar array and said battery storage system are directly couple to an input of said DC-DC converter and said SCR control logic monitors current flow in and out of said battery storage system and throttles said DC-DC converter to control the rate of said battery storage system charging and discharging.

8. An SDCR system comprising:
a. a plurality of PV strings configured to provide electricity to one more power sinks;
b. said power sinks comprising battery packs, buildings and a utility grid;
c. power from said plurality of PV strings delivered directly to an inverter;
d. said inverter converting DC current to a grid-compatible AC current;
e. said AC current supplied alternatively to a utility grid and one or more building loads.

9. The SDCR system of claim 8 further comprising:
a. two or more PV strings wherein each of said two or more PV strings operate at varied voltages:
b. at least one PV string operating at a higher voltage and matching operational voltage of a battery storage system and an inverter;
c. a second PV string operating at a lower voltage and coupled to a boost stage to convert power output to a uniform voltage consistent with said at least one higher voltage PV string.

10. The SDCR system of claim 8 further comprising:
a. an AC isolation and rectification module; and,
b. a buck/boost converter stage

11. An SDCR system for use with a single PV panel comprising:
a. a single PV panel;
b. a DC-DC converter;
c. a micro-inverter; and,
d. A battery pack.

12. The SDCR system of claim 11 further comprising:
a. an AC isolation and rectification module; and,
b. a buck/boost converter stage.

13. A method for improving efficiency and utility of a solar system via symmetric direct current regulation, comprising:
a. mapping the output voltage of a PV array to an operational voltage of a battery storage system and an inverter;
b. coupling an SDCR system to the solar system;
c. operating the solar system according to power requirements in various modes wherein:
d. at Mode 0, the SDCR system idling and no power is delivered to building loads, said battery energy storage system or the grid;
e. at Mode 1, the SDCR system is in a PV net metering mode where extremely low power level requirements for building loads exist and said battery storage system is full;
f. at Mode 2, the SDCR system is operating in a battery-supported demand shaving mode with no PV power generation;
g. at Mode 3, the SDCR system is demand shaving, net metering and delivering PV power to charge said battery storage system;
h. at Mode 4, the SDCR system is charging said battery storage system with power from the utility grid, based on no available PV power; and,
i. at Mode 5, the SDCR system is charging said battery storage system with power from the utility grid while the PV is delivering power to the utility grid in a net metering state.
